(19) United States
(12) Patent Application Publication
(10) Pub. No.: US 2017/0057683 A1
(43) Pub. Date: Mar. 2, 2017

(54) LABEL DRUM AUTO TIMED SHAFT ASSEMBLY

(71) Applicant: Niagara Bottling, LLC, Ontario, CA (US)

(72) Inventor: Thomas Goucher, Ontario, CA (US)

(73) Assignee: Niagara Bottling, LLC, Ontario, CA (US)

(21) Appl. No.: 15/219,065

(22) Filed: Jul. 25, 2016

Related U.S. Application Data
(60) Provisional application No. 62/210,653, filed on Aug. 27, 2015.

(51) Int. Cl. B65C 9/30

(52) U.S. Cl. CPC B65C 9/30; B65C 2210/0072

(57) ABSTRACT

An apparatus and method are provided for a label drum which may be simply calibrated with respect to label placing machinery, the label drum comprising: a drum; a first bushing including a cavity defined by an interior wall, wherein the first bushing is configured to couple with a second bushing including a cavity; and a shaft having a proximal portion defined by the shape of the interior wall of the cavity, such that the shaft may be received through the first and second bushing and will limit rotational positioning requirements therefore removing the time required for set up post installation.

### PRIORITY

This application claims the benefit of and priority to U.S. Provisional Application, entitled “Label Drum Auto Timed Shaft Assembly,” filed on Aug. 27, 2015 having application Ser. No. 62/210,653.

### FIELD

The field of the present disclosure relates generally to label drums. More particularly, the field of the present disclosure relates to an apparatus and a method for a label drum which may be simply calibrated with respect to label placing machinery.

### BACKGROUND

Labels are an efficient and cost-effective means of identifying and decorating a package or product, such as a bottle. In every major industry, various types of labels are applied to many types of containers at a high rate of speed to ensure that products are finalized in a timely manner.

Generally, labels are comprised of a face material that is coated on one side with an active adhesive. The face may be comprised of paper, plastic, reflective materials, foils, or vinyl, and may be provided in varying thicknesses, lengths, and weight. The label may be carried on a silicone-coated backing material, or a film, to easily release on demand.

As will be appreciated, while using labels produces a fast, efficient and simple outcome, operating label placing machinery generally offers certain challenges and complexities. For example, the label placing machines may not be economical to purchase, and may require service, sometimes every day, or multiple times a day.

One challenge to using labeling machines is that certain components within the machines require frequent servicing, such as a periodic application of grease. For example, most labeling machines include one or more drums configured to utilize various types of materials, such as label paper, backing paper, adhesives, grease, various lubricants, and the like. When the material is nearing depletion, it must be refilled. Replenishing a depleted material may entail, for example, removing a labeling drum from a shaft, applying grease, and re-installing the drum. However, every time the drum is removed and subsequently reinstalled, it must be re-calibrated so that the labelling process is timed appropriately. Generally, the reinstallation and recalibration process is very time consuming and slows the production process, thereby decreasing revenue and production output.

What is needed, therefore, is a label drum which may be automatically calibrated with respect to label placing machinery, whereby the label drum may be easily removed, serviced, and reinstalled without significantly delaying label placing processes.

### SUMMARY

An apparatus and method are provided for a label drum which may be simply calibrated with respect to label placing machinery. The label drum comprises a drum that is configured to receive a shaft. A first bushing includes an irregularly-shaped cavity defined by an interior wall and is configured to couple with a second bushing that includes a similar irregularly-shaped cavity defined by an interior wall. In some embodiments, the irregularly-shaped of the interior wall is an asymmetrical quadrilateral. Preferably, the upper bushing and lower bushing are configured to be fastened together, thereby retaining the drum there between, by using one or more fasteners. The shaft includes a proximal portion configured to mate with the irregular shape of the interior walls of the cavities, such that the shaft may be received through the first and second bushings. The irregular shape of the interior wall ensures that the shaft may be inserted through the cavities of the upper and lower bushing in only one angular position with respect to the drum. The one angular position decreases the time required for set up post installation.

In an exemplary embodiment, a label drum which may be simply calibrated with respect to label placing machinery comprises a drum; an upper bushing including a cavity defined by an interior wall, wherein the upper bushing is configured to mate with a lower bushing including a cavity; and a shaft having a proximal portion defined by the interior wall of the cavity, such that the shaft may be received through the upper and lower bushing.

In another exemplary embodiment, the upper bushing includes a plurality of holes. In another exemplary embodiment, the interior wall is asymmetrical quadrilateral. In another exemplary embodiment, the upper bushing and lower bushing are configured to mate using one or more fasteners.

In another exemplary embodiment, the proximal portion of the shaft is substantially flush with the upper bushing. In another exemplary embodiment, the upper and lower bushing retain the drum. In another exemplary embodiment, the shaft may be inserted through the cavities of the upper and lower bushing in only one position. In another exemplary embodiment, the upper bushing includes a lip portion that extends past a body portion. In another exemplary embodiment, the first and second bushing are comprised of an interior wall having the same shape.

In an exemplary embodiment, a method for simply calibrating a label drum with respect to label placing machinery comprises providing a drum configured to be received by an upper bushing including a cavity defined by an interior wall, wherein the upper bushing is configured to mate with a lower bushing including a cavity; and inserting a shaft through the cavity, the shaft having a proximal portion defined by the interior wall of the cavity, such that the shaft may be received through the upper and lower bushing, and whereby the cavity is configured to limit the drum to one axial insertion position relative to the shaft.

### BRIEF DESCRIPTION OF THE DRAWINGS

The drawings refer to embodiments of the present disclosure in which:

FIG. 1 illustrates a perspective view of an exemplary embodiment of a label drum in accordance with principles of the present disclosure;

FIG. 2A illustrates a top view of an exemplary embodiment of a label drum in accordance with principles of the present disclosure;

FIG. 2B illustrates a side plan view of an exemplary embodiment of a label drum in accordance with principles of the present disclosure;

FIG. 2C is a sectional view of the exemplary embodiment of the label drum, illustrated in FIG. 2B, taken along a midline of the label drum according to principles of the present disclosure;

FIG. 3A is a top view illustrating an exemplary embodiment of a bottom bushing of a label drum in accordance with principles of the present disclosure;

FIG. 3B is a side plan view illustrating the exemplary embodiment of the bottom bushing of FIG. 3A, according to present disclosure;

FIG. 3C is a detailed view illustrating a portion of the exemplary embodiment of the bottom bushing illustrated in FIG. 3B in accordance with the present disclosure;

FIG. 4A is a top view illustrating an exemplary embodiment of an upper bushing of a label drum in accordance with principles of the present disclosure;

FIG. 4B is a side plan view illustrating the exemplary embodiment of the upper bushing of FIG. 4A, according to present disclosure;

FIG. 4C is a detailed view illustrating a portion of the exemplary embodiment of the upper bushing illustrated in FIG. 4B in accordance with the present disclosure;

FIG. 5A illustrates a side view of an exemplary embodiment of a shaft for use with a label drum in accordance with the principle of the present disclosure;

FIG. 5B illustrates a longitudinal view of a proximal portion of the shaft illustrated in FIG. 5A, according to the present disclosure; and

FIG. 5C illustrates a detailed view of the proximal portion of the shaft illustrated in FIG. 5B in accordance with the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

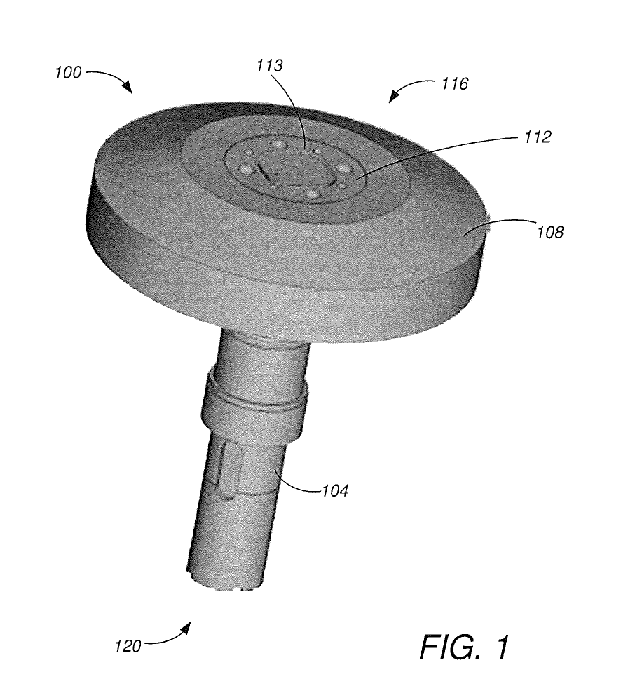

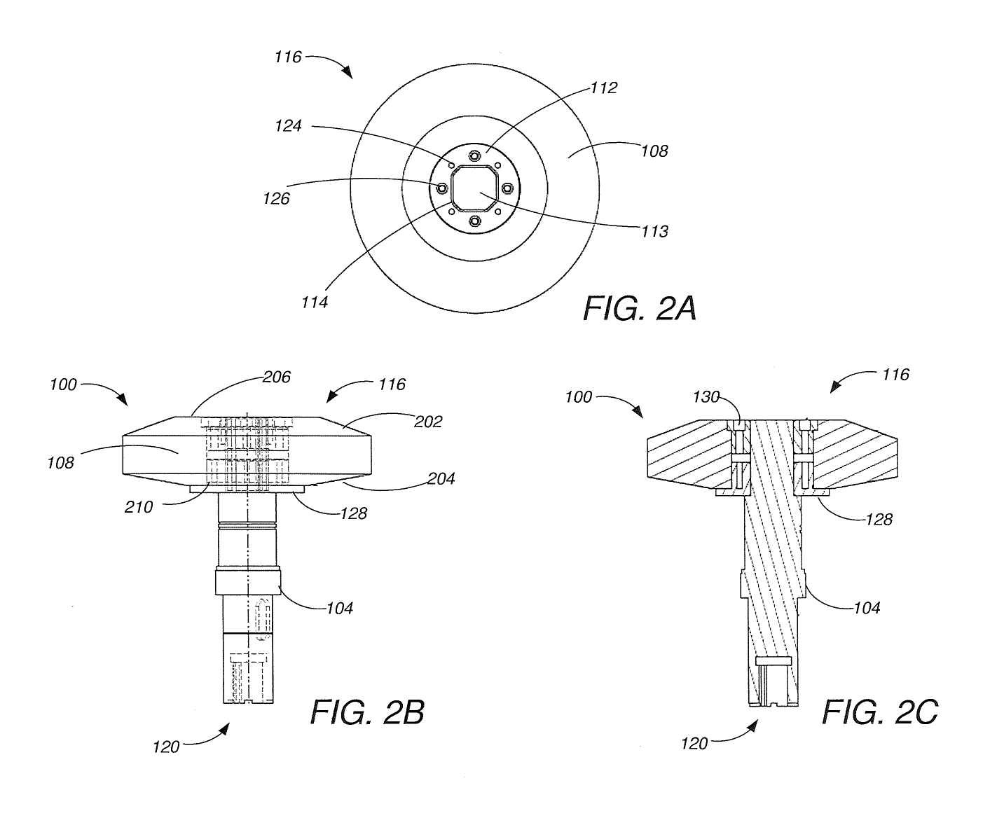

FIGS. 1-2C show an exemplary embodiment of a label drum 100 in accordance with one embodiment of the present disclosure. The present disclosure generally describes a shaft 104 that mates with a drum 108 by way of an upper bushing and a lower bushing, such that the upper and lower bushings retain the drum 108 upon the shaft. More particularly, the label drum 100 illustrated in FIGS. 1-2C comprises a proximal portion 116 and a distal portion 120. The proximal portion 116 comprises the drum 108, an upper bushing 112, and a lower bushing 128. The drum 108 may be made of any number of materials including, by way of non-limiting example, metals, plastics, rubbers, any combination thereof, and the like.

In the embodiment illustrated in FIGS. 1-2C, the shaft 104 extends through the bushings 112, 128, such that the shaft 104 is substantially flush with a top surface of the drum 108 at the proximal portion 116. In an exemplary embodiment, the drum 108 is substantially cylindrical, taking the shape of a wheel or similar structure, although any shape may be used. In an exemplary embodiment, the shaft 104 has a diameter of substantially 2.36 inches, and a length of substantially 10.47 inches, although it should be understood that a wide variety of diameters and lengths may be implemented without straying beyond the scope of the present disclosure.

The upper bushing 112 and the lower bushing 128 are configured to retain the drum 108 desirably positioned on the shaft 104, as best shown in FIG. 1. As illustrated in FIGS. 2A-2C, the upper bushing 112 and the lower bushing 128 are substantially cylindrical, and each comprises a cavity 113 defined by an interior wall 114. The interior wall 114 is configured to prevent movement of the drum 108 relative to the shaft 104. As such, the interior wall 114 may be configured with any number of different shapes, including by way of non-limiting example, geometric, symmetric, asymmetric, round, square, or any thereof that are suitable for preventing relative movement between the drum 108 and the shaft 104. It is to be understood that the bushings 112, 128 may comprise any shape suitable for supporting the drum 108 and the shaft 104. The upper and lower bushings 112, 128 may be comprised of the any material suitable for retaining the drum 108 upon the shaft 104 without limitation. It is envisioned, therefore, that the upper and lower bushings 112, 128 may be comprised of, by way of non-limiting example, any of various metals, plastics, rubbers, or any combination thereof.

It will be appreciated that the interior wall 114 comprises a peripheral configuration of the cavity 113 which is configured to receive the shaft 104 in any of a specific number of axial orientations. For example, in some embodiments, the peripheral configuration of the cavity 113 may be configured so as to receive the shaft 104 in any of four axial orientations, corresponding to 90-degree rotational orientations of the drum 108 relative to the shaft. In some embodiments, the peripheral configuration of the cavity 113 may be configured to limit the shaft 104 to two axial orientations, thus limiting the drum 108 to 180-degree orientations relative to the shaft 104. Preferably, however, the peripheral configuration of the cavity 113 is configured to limit the drum 108 to one axial position relative to the shaft 104, as described herein. In one embodiment, the upper and lower bushings 112, 128 preferably are coupled to one another such that the cavity 113 within both of the bushings 112, 128 are aligned so as to receive a shaft 104 through both of the bushings, as shown in FIG. 1. As will be appreciated, limiting the shaft 104 to a specific number of axial positions relative to the drum 108 advantageously facilitates removing and reinstalling the drum from the shaft 104 during servicing of the label drum 100 without any need for adjusting timing of the drum 108, or the label drum, with respect to other production machinery.

As best illustrated in FIG. 2A, the interior wall 114 comprises an asymmetrical quadrilateral configuration to retain the drum rotationally, relative to the shaft 104. It should be understood, however, that any number of configurations and interior walls may be incorporated so as to define an external boundary or peripheral configuration of the cavity 113. As such, it is envisioned that the interior wall 114 of the cavity 113 comprises a shape having one or more of the following attributes, by way of non-limiting example: geometric, symmetric, asymmetric, round, square, or any combination thereof. It is to be understood, however, that the shape selected with respect to the interior wall 114 preferably allows for the one axial position of the drum 108 and the shaft 104 as discussed herein.

As best shown in FIG. 2A, the upper bushing 112 comprises a plurality of holes 124 and 126. Similarly, the lower bushing 128 comprises a plurality of holes 122 position so as to align with the holes 126 in the upper bushing 112. In some embodiments, the lower bushing 128 may further comprise a plurality of holes aligned with the holes 124 of the upper bushing 112. The holes 122, 124, 126 may be formed by way of any of various methods known in the art, including, by way of non-limiting example, drilling, boring, tapping, molding and the like. Further, any number of holes may be included, as deemed necessary. In one exemplary embodiment, adjacent holes 124, 126 are disposed on the upper bushing 112 with a separation distance of substantially 1.575 inches, as measured from a centerline of each hole. It is to be understood, however, that the holes 124, 126 may be implemented with a wide variety of sizes, diameters, depths and spacing without straying beyond the scope of the present disclosure.

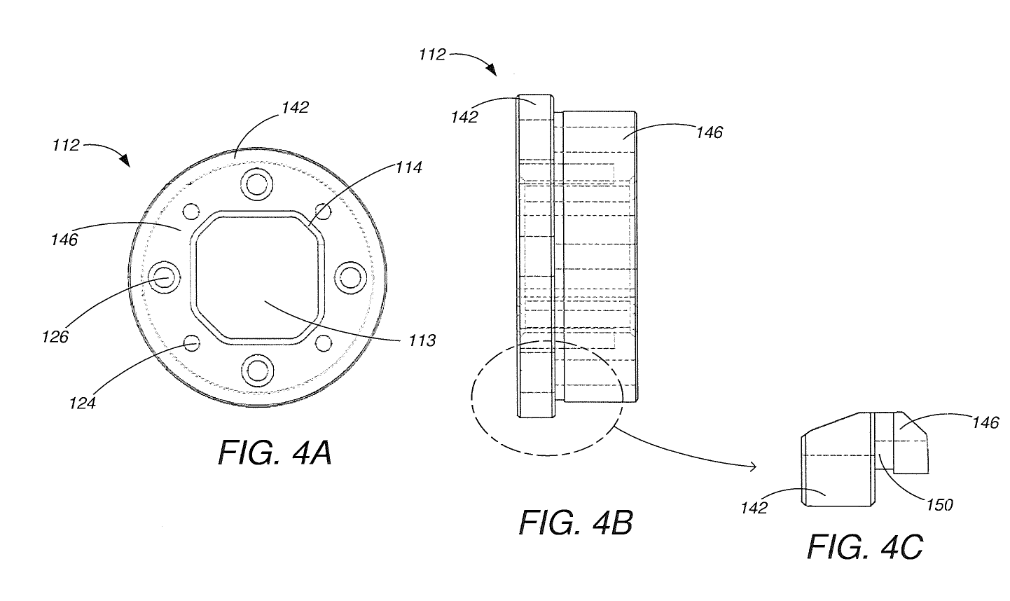

As will be appreciated, the holes 122, 124, 126 may each be configured to receive a bolt 130, screw or other similar fastener so as to couple the upper bushing 112 with the lower bushing 128, such that the shaft 104 is retained in the cavity 113. As best illustrated in FIG. 4A, the holes 124, 126 are disposed on the upper bushing 112, such that the holes surround the cavity defined by an interior wall 114. In some embodiments, the holes may alternate between large holes 126 to small holes 124 around the outside perimeter of the interior wall 114. In an exemplary embodiment, the larger holes 126 have a radius of substantially 1.575 inches, and the smaller holes 124 have a radius of substantially 1.114 inches, although any radius may be used to achieve a desired configuration.

As best shown in FIG. 2A, the lower bushing 128 is aligned with the holes 122, 126 may comprise threads configured to accept a threaded portion of the bolt 130, thereby facilitating bolting the upper and lower bushings 112, 128 together. As those having skill in the art will appreciate, the larger holes 126 may accept a different type of screw, adapter, or fastener as compared to the smaller holes. The arrangement of holes generally is contingent upon the configuration of the interior wall 114. For example, interior walls having larger dimensions extend closer to the peripheral edge of the upper and/or lower bushing, thereby leaving less room for large screws, or other similar fasteners. Conversely, possessing relatively smaller dimensions lends greater surface area to accommodate larger holes between the cavity 113 and the peripheral edge.

As shown in FIGS. 2B-2C, the drum 108 is coupled with the shaft 104, as described herein. In an exemplary embodiment, the drum 108 is disk-shaped, and comprises a plurality of peripherally chamfered edges 202 and 204. The drum 108 extends longitudinally towards the upper bushing 112, and transitions gradually to its full thickness, such that a flat portion 206 of the drum is substantially flush with the upper bushing 112. Similarly, the drum 108 gradually transitions to a flat portion 210, extending longitudinally toward the lower bushing 128. As will be appreciated, any number of various different shapes and configurations may be incorporated into the drum 108 without straying beyond the scope of the present disclosure.

FIG. 2C shows a cross-sectional side view of the label drum 100 illustrated in FIG. 2B, taken along a midline of the label drum. The shaft 104 couples with the drum 108 such that the shaft is substantially flush at the proximal portion 116 of the label drum 100. In one embodiment, the shaft is not substantially flush at the distal portion, and in fact the shaft may be substantially recessed, or extend outward, past the upper bushing. A plurality of bolts 130 are configured to mate the plurality of holes of the upper bushing with the lower bushing. The distal portion 120 of the label drum may include one or more interfaces configured to connect the shaft to other components within a larger machine or system. In some embodiments, the distal portion 120 may be configured to have the same general shape as the shaft 104.

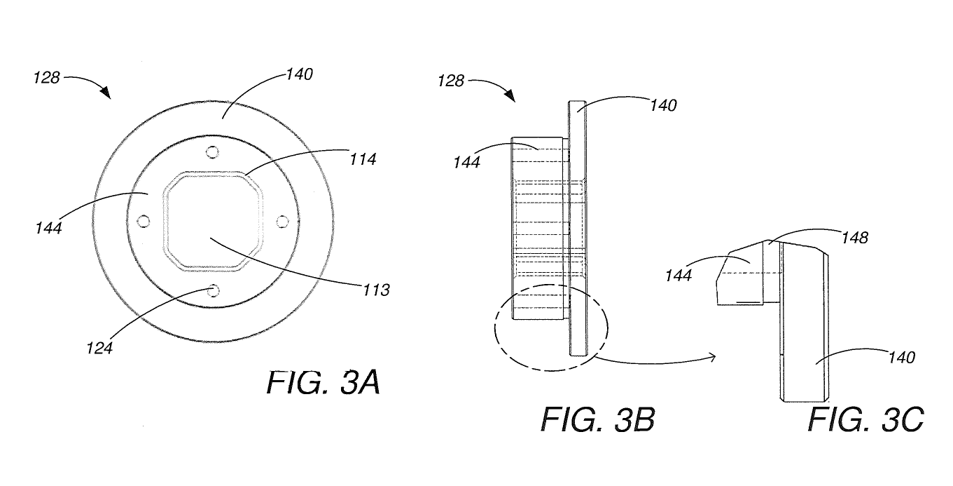

FIGS. 3A and 3B respectively show top and side views of the bottom bushing 128 illustrated in FIGS. 1-2C. The bottom bushing 128 comprises a disk portion 140 extending peripherally from a cylindrical body 144. Cylindrical body 144 extends longitudinally beyond the disk portion 140 and cooperates with the upper bushing 112. The cylindrical body 144 of the bottom bushing 128 comprises a plurality of holes 122 as described herein. Preferably, bolts 130 or any other types of suitable fasteners are received through the holes 126 of the upper bushing 112 and mate with the holes of the lower bushing 128. In one exemplary embodiment, the cylindrical body 144 has a diameter of substantially 3.934 inches, and extends longitudinally beyond the disk portion 140 a thickness of substantially 1.235 inches. In a preferred embodiment, the disk portion may have a diameter of substantially 5.488 inches and a depth of substantially 0.390 inches. It is envisioned, however, that a wide variety of diameters, depths, and thicknesses may be implemented with respect to the cylindrical body and disk portion of the bottom bushing without straying beyond the scope of the present disclosure.

As shown in FIGS. 3B and 3C, a relief region 148 is disposed between the disk portion 140 and the cylindrical body 144. In some embodiments, the disk portion 140 and the cylindrical body 144 may comprise separate components that may be adhered together along the relief region 148. In some embodiments, the separate components comprising the bottom bushing 128 may be made of distinct materials. It is envisioned that bottom bushing comprising the disk portion 140, the cylindrical body 144 and the relief region 148 may be formed from a single piece of material.

FIGS. 4A and 4B are respective top and side views of the embodiments of the upper bushing 122 illustrated in FIGS. 1-2C. As discussed above, the upper bushing 112 includes the cavity 113 defined by the interior wall 114, as well as the plurality of holes 124 and 126. The plurality of holes 124, 126 may be formed by way of any of a plurality of known methods, including by way of non-limiting example, drilling, boring, molding, tapping and the like. Furthermore, any number of holes may be formed in the upper bushing 112. As will be appreciated, the holes 124, 126 may be both configured to receive a bolt such as the bolt 130, a screw or similar fastener to couple the upper bushing 112 with the lower bushing 128 as described herein. In some embodiments, at least a portion of the plurality of holes 124, 126 further comprises a countersunk configuration to receive a head portion of the bolt 130, such that the head portion is below a top-most surface of the upper-bushing 112, as shown in FIG. 1. As will be appreciated by those skilled in the art, any number of holes, sizes, specific configurations or combinations may be included in the upper bushing 112 without deviating beyond the scope of the present disclosure.

As shown in FIG. 4B, the upper bushing 112 further a lip portion 142 extending peripherally beyond a body portion 146. As best shown in FIG. 4C, a relief region 150 is disposed between the body portion 146 and the lip portion 142. In an exemplary embodiment, the body portion 146 has a diameter of substantially 3.934 inches, the lip portion 142 has a diameter of substantially 4.374 inches, with a thickness of substantially 0.50 inches. Preferably, however, the lip portion 142 is formed so as to be received into a countersink of the drum 108, as shown in FIG. 2C. It should be understood, however, that a wide variety of diameters and thicknesses may be implemented with respect to the body portion 146 and the lip portion 142 of the upper bushing 112 without straying beyond the scope of the present disclosure. It will be appreciated that the lip portion 142 serves to maintain the mounting of the drum 108 in cooperation with the bushings 112, 128 as shown in FIG. 1. Moreover, the upper bushing 112 is preferably formed out of a single piece of metal, although any suitably rigid materials may be used. In embodiments, the body portion 146 and the lip portion 142 may be adhered together along the relief portion 150.

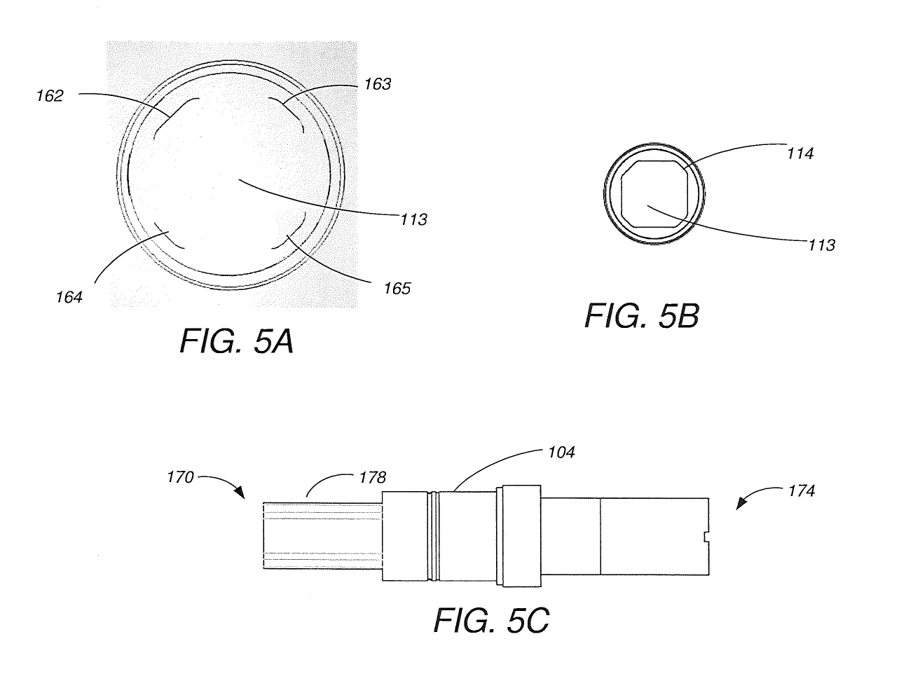

FIGS. 5A-5B illustrate top views of the shaft 104 in accordance with the principles of one embodiment of the present disclosure, respectively. As shown in FIG. 5A, in an exemplary embodiment, the interior wall 114 comprises of elements 162, 163, 164, and 165; each have a slightly varying length and shape, such that each of the elements 162-165 form a corresponding corner of the interior wall 114. As shown in FIG. 5B, it is to be appreciated that the elements 162, 163, 164 and 165 may be connected to one another to form the interior wall 114, thereby defining the cavity 113. However, such connection is not shown in FIG. 5A in order to bring special attention to the exemplary shape of the interior wall 114. In one preferred embodiment, the shaft 104 has a length of substantially 13.736 inches. In one preferred embodiment, the shaft comprises of an insertion region 178 that has a length of substantially 3.66 inches. It is envisioned, however, that a wide variety of lengths and diameters may be implemented with respect to the shaft without straying beyond the scope and spirit of the present disclosure.

FIG. 5C illustrates a side view of a shaft 104 of an exemplary embodiment of a label drum in accordance with the principles of one embodiment of the present disclosure. As shown, the shaft 104 includes a distal portion 174 and a proximal portion 170. The proximal portion 170 is received through the bushings 112, 128 such that the drum 108 is retained. In an exemplary embodiment, once the shaft 104 is received through the upper and lower bushings, the proximal portion 170 is substantially flush with the upper bushing 112. In one embodiment, the shaft is recessed in comparison to the upper bushing. In one embodiment, the shaft extends past the upper bushing. Persons having skill in the art will appreciate that the proximal portion of the shaft 104 shares the same shape as the same interior wall 114, such that the shaft couples with the cavity 113 defined by the interior wall 114. In one preferred embodiment, the cavity 113 is configured to limit the drum 108 to one axial position relative to the shaft 104, as described herein. The distal portion 174 of the shaft may be coupled with other components as necessary with respect to label placing processes. Although the shaft 104 is shown as having a substantially cylindrical shape, a variety of other shapes may be implemented, including squares, triangles, or other geometric and/or symmetrical/asymmetrical shapes without limitation.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A label drum which may be simply calibrated with respect to label placing machinery, the label drum comprising:
a drum;
an upper bushing including a cavity defined by an interior wall, wherein the upper bushing is configured to mate with a lower bushing including a cavity; and
a shaft having a proximal portion defined by the interior wall of the cavity, such that the shaft may be received through the upper and lower bushing.

2. The label drum of claim 1, wherein the upper bushing includes a plurality of holes.

3. The label drum of claim 1, wherein the interior wall is asymmetrical quadrilateral.

4. The label drum of claim 1, wherein the upper bushing and lower bushing are configured to mate using one or more fasteners.

5. The label drum of claim 1, wherein the proximal portion of the shaft is substantially flush with the upper bushing.

6. The label drum of claim 1, wherein the upper and lower bushing retain the drum.

7. The label drum of claim 1, wherein the shaft may be inserted through the cavities of the upper and lower bushing in only one position.

8. The label drum of claim 1, wherein the upper bushing includes a lip portion that extends past a body portion.

9. The label drum of claim 1, wherein the first and second bushing are comprised of an interior wall having the same shape.

10. A method for simply calibrating a label drum with respect to label placing machinery, the method comprising:
providing a drum configured to be received by an upper bushing including a cavity defined by an interior wall, wherein the upper bushing is configured to mate with a lower bushing including a cavity; and
inserting a shaft through the cavity, the shaft having a proximal portion defined by the interior wall of the cavity, such that the shaft may be received through the upper and lower bushing, and whereby the cavity is configured to limit the drum to one axial insertion position relative to the shaft.
